(19) United States
(12) Patent Application Publication
(10) Pub. No.: US 2011/0188032 A1
(43) Pub. Date: Aug. 4, 2011

(54) Far-field superlensing

(76) Inventors: Ravi Verma, La Canada, CA (US); Hyesog Lee, Norwalk, CA (US)

(21) Appl. No.: 12/658,342

(22) Filed: Feb. 4, 2010

(51) Int. Cl. G01N 21/00; G02B 3/00; G02B 27/56

(52) U.S. Cl. 356/237.2; 359/642; 359/586; 359/580

(57) ABSTRACT

An apparatus for creating a sub-wavelength image in the farfield. In an example embodiment, the apparatus includes a far-field superlens that is adapted to generate a sub-wavelength image or a sub-diffraction-limited image at a far field distance from a negative-index material included in the superlens. The example far-field superlens includes a positive-index material and an adjacent positive-index material. The negative-index material has an output aperture at a first surface. A second surface or interface is positioned at a far field distance from the negative-index material such that a cavity or gap is formed between the second surface and the first surface, wherein the second surface represents an imaging surface. The gap may be filled with a dielectric material or may include a vacuum or air. In a more specific embodiment, the superlens further includes a first mechanism for producing one or more sub-diffraction-limited beam features at a far field distance from the negative-index layer via the cavity in which propagating electromagnetic energy from the incident electromagnetic energy propagates.

### ACKNOWLEDGEMENT OF GOVERNMENT SUPPORT

This invention was made with Government support under Contract No. W31P4Q-09-C-0262 awarded by DARPA. The Government may have certain rights to this invention.

### BACKGROUND OF THE INVENTION

1. Field of Invention

This invention relates to imaging devices, systems, and methods. Specifically, the present invention relates to superlenses and related devices, systems, and methods that use evanescent electromagnetic energy.

2. Description of the Related Art

Imaging devices, systems, and methods are employed in various demanding applications, including lithography used to construct integrated circuits and MicroElectromechanicalSystems (MEMS), metrology used to ascertain defects or features of vary small structures, such as components of an integrated circuit, and so on. Such applications often demand imaging devices that can accurately generate very small images or otherwise output high resolution patterns.

Imaging devices capable of high resolution imaging are particularly important in the semiconductor industry, which continues to push for higher resolution imaging devices to reduce integrated circuit component sizes to enhance circuit performance.

Generally, semiconductor industry has relied upon conventional refractive lens elements for both lithography and metrology tooling. Attempts to accommodate smaller circuit feature sizes have included increasing the numerical apertures of lenses and reducing the wavelengths of light used for imaging. However, the numerical apertures of conventional refractive lens elements are typically limited to 1. Accordingly, attempts to improve lens imaging resolution by increasing the numerical aperture have been limited. Generally, use of conventional refractive lenses cannot accurately image feature sizes smaller than the lens diffraction limit, which is typically greater than approximately ½ the wavelength of light employed for the imaging.

Attempts to achieve higher resolution images for lithography applications have included use of superlenses and accompanying evanescent electromagnetic energy, also called near-field energy emanating from the superlenses. For the purposes of the present discussion, superlens may be any lens capable of imaging features at, or smaller than, the diffraction limit associated with electromagnetic energy applied to the lens. This typically corresponds to a numerical aperture greater than 1. A lens may be any device for affecting the propagation of energy, such as electromagnetic energy.

Superlenses may yield high-resolution images with feature sizes less than the diffraction limit associated with a conventional refractive lens. However, evanescent electromagnetic energy emanating from the output aperture of a superlens typically becomes negligible at distances beyond the so-called near field of the lens. The near field is generally within ⅓ of a wavelength from the superlens output aperture and corresponds to a region wherein evanescent fields are present. The near field often does not extend to more than 10-20 nanometers from a superlens output aperture. With conventional superlenses, an imaging surface typically must be positioned within the near field of the output aperture to enable lithography. Stringent spacing requirements between the position of the imaging surface and the output aperture of the superlens have proven problematic for the construction and operation of practical lithography and metrology systems.

### SUMMARY OF THE INVENTION

The need in the art is addressed by an apparatus for creating a sub-wavelength image. In an example embodiment, the apparatus includes far-field superlens. For the purposes of the present discussion, a far-field superlens may be any superlens adapted to generate a sub-wavelength image/pattern or a sub-diffraction-limited image/pattern at a far field distance from a negative-index material included in the superlens.

The example far-field superlens includes a positive-index material and an adjacent negative-index material. The negative-index material has an output aperture at a first surface. A second surface or interface is positioned at a far field distance from the negative-index material such that a cavity or gap is formed between the second surface and the first surface, wherein the second surface represents an imaging surface. The gap may be filled with a dielectric material or may include a vacuum or air.

The superlens further includes a first mechanism for producing one or more sub-diffraction-limited patterns in the nearfield of the superlens, a second mechanism for amplifying the electric fields associated with these patterns, and a third mechanism for interacting these field patterns with a propagating wave that conveys the sub-diffraction limited patterns into the farfield.

In one specific embodiment, the resonant cavity supplies an amplified propagating wave, a grating provides sub-diffraction limited patterns in the nearfield (either via the standing waves associated with gratings just larger than the diffraction limit, or with the evanescent waves associated with sub-diffraction limited gratings)

For the purposes of the present discussion, a beam feature may be any component or portion of an image corresponding to a beam or component of a beam used to generate the image. An example beam feature includes a spot on a surface created by a beam, or a grouping of spots on a surface created by a beam that has been patterned to produce the spots. A beam feature may also correspond to a feature of a mask used to pattern an incident beam.

In one specific embodiment, the cavity is adapted to support resonance for the propagating wave that interacts with the amplified evanescent wave at the surface, and a grating pattern just greater than the diffraction limit is used to scatter in the propagating light and to simultaneously generate an evanescent wave corresponding to the standing waves associated with lateral components of the diffracted light. In this embodiment, the propagating wave will convey evanescent waves associated with the standing wave pattern, which will have a spatially doubled frequency, compared to the grating pitch.

In a second embodiment, the grating pitch can be smaller than the diffraction limit. In this case, light incident on the grating pitch will only generate surface evanescent waves, and propagating light of the same phase must be introduced into the cavity from the other side. In this embodiment, the propagating light will convey evanescent waves of the same spatial frequency as the grating. Alternate embodiments using the same principles can also be constructed.

In all embodiments, the propagating light interacts with the surface evanescent waves, and conveys the surface waves into the farfield. If the medium outside the dielectric cavity has the right indices, then this medium further supports evanescent waves that have the same spatial frequency as the evanescent waves in the nearfield.

The novel designs disclosed herein are facilitated by the use of metamaterial far-field superlens that exhibits certain superlens characteristics, but which also exploits interference, the interaction of propating waves with evanescent waves and other applicable phenomenon, to create sub-diffraction-limited patterns in the farfield. The sub-diffraction-limited patterns may be created at locations beyond the near field of an output aperture of a material layer characterized by a negative index of refraction.

For the purposes of the present discussion, a metamaterial lens may be a lens that includes a combination of materials with negative and positive indices. A negative-index material may be any material with an index of refraction with a negative real part.

Extension of sub-diffraction-limited information inherent in evanescent electromagnetic energy to distances beyond the far field of a superlens output aperture may greatly facilitate high-resolution lithography and metrology applications. Furthermore, certain embodiments disclosed herein may employ interference effects between propagating electromagnetic energy and/or evanescent electromagnetic energy in the cavity to effectively double or quadruple the spatial frequency or resolution of a pattern characterizing the incident electromagnetic energy. The resulting enhanced-resolution pattern is presented for imaging at far field distances from an output aperture of the superlens.

### BRIEF DESCRIPTION OF THE DRAWINGS

FIG. 1 is a diagram of a first example single-far-field superlens nanolithography system according to a first embodiment for performing immersion lithography.

FIG. 2 is a partially exploded perspective view of an alternative embodiment of the nanolithography system of FIG. 1.

FIG. 3 is a diagram of a second example superlens imaging device illustrating propagation of electromagnetic energy within a cavity formed by a dielectric layer positioned adjacent to a negative-index layer.

FIG. 4 is a diagram illustrating example electromagnetic field intensity patterns in the cavity of FIG. 3 for a dielectric layer thickness of approximately 90 nanometers.

FIG. 5 is a diagram illustrating example electromagnetic field intensity patterns in the cavity of FIG. 3 for a dielectric layer thickness of approximately 180 nanometers.

FIG. 6 is a diagram illustrating example electromagnetic field intensity patterns in the cavity of FIG. 3 for a dielectric layer thickness of approximately 267 nanometers.

FIG. 7 is a flow diagram of an example method adapted for use with the superlenses of FIGS. 1 and 3.

FIG. 8 is a diagram of a single-far-field superlens metrology (inspection) system according to a third example embodiment.

### DESCRIPTION OF THE INVENTION

While embodiments are described herein with reference to particular applications, it should be understood that the embodiments are not limited thereto. Those having ordinary skill in the art and access to the teachings provided herein will recognize additional modifications, applications, and embodiments within the scope thereof and additional fields in which the present invention would be of significant utility.

For the purposes of the present discussion, nanolithography may be any method that uses an imaging system or device to create physical features or things that are characterized by one or more dimensions less than approximately 500 nanometers. A feature or thing with dimensions less than approximately 500 nanometers is called a nanoscale feature. An imaging system or device may be any system or device capable of projecting or otherwise forming an image or projection of an image. Hence, a nanolithography system may be an imaging system. For the purposes of the present discussion, metrology may be any method that inspects patterns on a wafer, or on a mask, for defects.

The near field may be any region about a surface in which an evanescent field may be detected. For the purposes of the present discussion, an evanescent field may be any electric and/or magnetic field arising from evanescent electromagnetic energy. Evanescent electromagnetic energy may be any energy existing in or represented by an evanescent wave. An evanescent wave may be any electromagnetic wave with an intensity that exhibits exponential decay with distance from a boundary at which the wave was formed. Evanescent waves often form at a boundary between two media with different refractive indices. Evanescent waves and corresponding fields are often most intense within one-third of a wavelength from the boundary or surface from which the evanescent waves emanate. Evanescent waves often form on an opposite side of a surface when incident waves travelling in a medium undergo total internal reflection at the surface of the medium, where the waves are incident on the surface at an angle near or greater than the critical angle of incidence. Evanescent waves also typically form at an output aperture of a superlens or at an output surface of a material or layer characterized by a negative index of refraction for the working wavelength of electromagnetic energy.

A near field distance may be a distance corresponding to a decay length of evanescent electromagnetic energy emanating from a surface. The near field distance is often approximately ⅓ of the wavelength of electromagnetic energy used to generate evanescent electromagnetic energy emanating from the surface.

The evanescent electromagnetic energy, also called evanescent waves, may carry sub-diffraction-limited information, i.e., they may carry image information for resolutions smaller than the diffraction limit associated with a conventional lens. However, evanescent waves typically decay exponentially with distance from an interface at which the evanescent waves originate. Thus, evanescent exponentially decaying waves decay out in the near field, which often does not extend more than 10-20 nm from an interface.

Once the evanescent waves have substantially dissipated, the remaining electromagnetic field typically comprises the propagating waves that may carrying information about objects larger than the diffraction limit, unless the propagating waves are adjusted to transport sub-diffraction-limited information, as disclosed herein.

For the purposes of the present discussion, a sub-diffraction image may be any image with feature sizes that are less than the diffraction limit of a conventional lens, where a conventional lens may be any lens that is not a superlens. A superlens may be any lens that includes a material with an index of refraction that includes a negative real part over frequencies of electromagnetic energy used for imaging via the superlens. A sub-wavelength image may be any image with feature sizes that are less than ½ the wavelength of electromagnetic energy used as a source for imaging.

For the purposes of the present discussion, propagating electromagnetic energy may be any electromagnetic energy capable of far-field propagation, i.e., propagation beyond the near field, where the propagating waves are not characterized by conventional evanescent-field decay lengths from a surface.

The diffraction limit associated with electromagnetic energy of wavelength λ limits feature sizes (F) that can be imaged to approximately:

F=k(λ/N_{A}), [1]

where k is a coefficient that encapsulates process-related factors, and N_{A} is the numerical aperture of a lens used for imaging as seen from the surface upon which the image is formed. Generally, the diffraction limit suggests that light cannot be focused smaller than a predetermined fraction of its wavelength. In practice, the fraction is often approximately 0.5. For the purposes of the present discussion, light may be any optical energy, where optical energy may be any energy associated with photons, and may be contained in electric and magnetic fields in electromagnetic energy associated with the photons.

Certain embodiments disclosed herein overcome the diffraction limit by employing surface plasmon resonance to amplify evanescent waves in the near field, and by employing the interaction of the evanescent waves with propagating waves to convey the evanescent pattern to the farfield, and by employing interference effects to recreate the evanescent waves in the far field, i.e., at distances beyond the near field.

For clarity, various well-known components, such as light sources, and collimating systems, translation stages, and so on, have been omitted from the figures. However, those skilled in the art with access to the present teachings will know which components to implement and how to implement them to meet the needs of a given application. Furthermore, the figures are not necessarily drawn to scale.

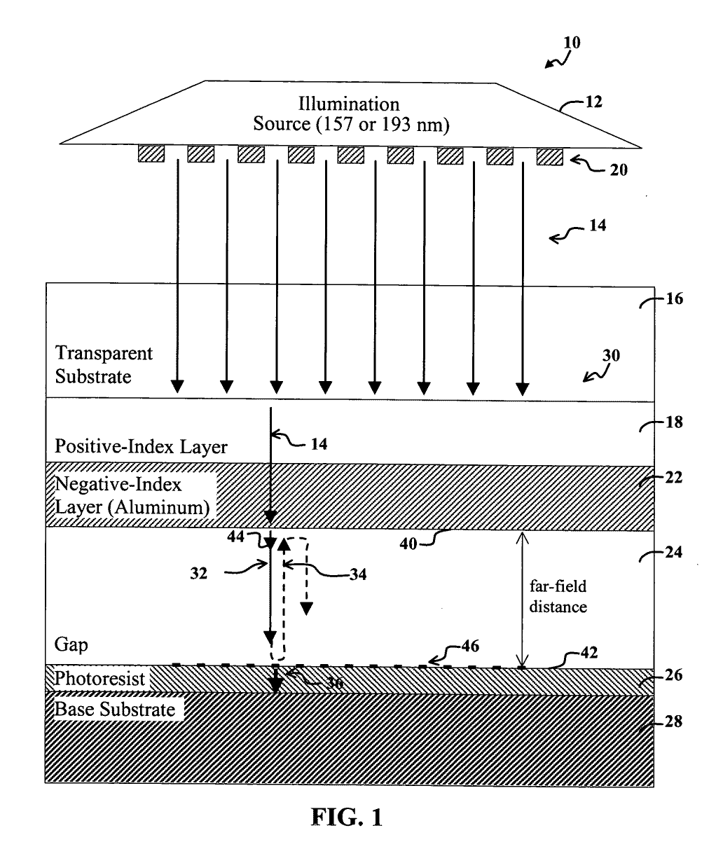

FIG. 1 is a diagram of a first example single-far-field superlens nanolithography system 10 according to a first embodiment for performing immersion lithography. For the purposes of the present discussion, a lithography system may be any device or collection of devices adapted to facilitate using an image or projection of an image, such as a mask pattern or other image, to create one or more physical features in or on a material. A nanolithography system may be any lithography system capable of facilitating the creation of nanometer-scale features. A nanometer-scale feature, also called a nanoscale feature, may be any feature or thing with one or more dimensions less than approximately 500 nanometers.

The system 10 includes an illumination source 12 that outputs patterned incident electromagnetic energy 14, which is patterned via a mask 20. The incident electromagnetic energy 14, also called incident light 14, is characterized by a spatial frequency corresponding to the separations between the beams 14 and the widths of the beams 14.

For the purposes of the present discussion, the spatial frequency of the incident electromagnetic energy is inversely proportional to the average separation distance between beams, such as the beams 14, of patterned incident electromagnetic energy 14.

A transparent substrate 16 is substantially transparent to the electromagnetic energy 14. The transparent substrate 16 is adjacent to a positive-index layer 18, and a negative-index layer 22 of a superlens 30. A gap 24, also called a gap layer or cavity, separates the negative-index layer 22 from a photosensitive layer 26, which is a photoresist layer 26 in the present specific embodiment. The photoresist layer 26 is disposed on a base substrate 28.

For the purposes of the present discussion, a positive-index material may be any material with an index of refraction, also called refraction index, characterized by a positive real part. Similarly, a negative-index layer may be any material characterized by an index of refraction with a negative real part.

The positive-index layer 18 may be a dielectric and may be made from any suitable positive-index material. In the present specific embodiment, the positive-index layer 18 is a dielectric material that is less than 50 nanometers thick and is substantially transparent to the electromagnetic energy 14. For the purposes of the present discussion, a dielectric may be any non-metal insulator or other material that is substantially not electrically conductive at voltages less than the breakdown voltage of the dielectric. An example dielectric is silica.

The negative-index layer 22 may be made from any suitable index material, such as aluminum (Al). The negative-index layer 22 is also called the superlens layer. In the present specific embodiment, the negative-index layer 22 is an aluminum layer that is less than approximately 50 nanometers thick.

An output aperture 40 (called the first surface) of the negative-index layer 22 faces a top surface 42 of a photoresist layer 26 across a gap 24, also called a cavity. The photoresist layer 26 is disposed on top of a base substrate 28, such as silicon. Those skilled in the art will appreciate that the gap 24 may be air, vacuum, or a suitable dielectric or other medium that can support both evanescent fields and propagating electromagnetic energy.

In operation, the illumination source 12 and a mask pattern 20 produce the beam of patterned electromagnetic energy 14, which is characterized by a center frequency corresponding to a wavelength of 157 (or 193) nanometers. However, other wavelengths of electromagnetic energy may be employed without departing from the scope of the present teachings.

The mask 20 exhibits a desired pattern to be imaged on the photoresist 26. The mask 20 is made from a material that is substantially opaque to the electromagnetic energy. Generally, the mask material is chosen to have a relatively low skin depth of less than approximately 15 nanometers, although materials with larger skin depths may be employed. The mask 20 may be made from Tungsten (W) that is approximately 50 nanometers thick. For the purposes of the present discussion, a mask may be any device or thing that selectively blocks a desired wavelength of electromagnetic energy in a desired pattern or shape.

The photoresist layer 26 may be made from any suitable photosensitive material. A photosensitive material or layer may be any material or layer that changes properties, such as mechanical, chemical, electrical, or other properties, in response to electromagnetic energy of a predetermined wavelength or intensity. In the present specific embodiment, photoresist layer 26 changes solubility in response to exposure to the electromagnetic energy 14.

The patterned light 14 passes through the positive and negative index layers 18 and 22, respectively. Upon incidence at the gap-photoresist interface, i.e., second surface 42, a fraction 32 of the patterned light 14 reflects back, resulting in reflected light 34.

The fraction of returned energy corresponding to the reflected light 34 depends upon the refractive index contrast between the gap 24 and the photoresist layer 26. This reflected energy 34 is further re-reflected by the negative index layer 22 at the first surface 40. Accordingly, a cavity resonance phenomenon is setup within the gap 24.

The cavity resonance phenomenon results in strong Electric field patterns associated with the propagating waves. If the spatial frequency of the patterned light 14 is comparable to the diffraction limit, then the standing waves associated with this pattern will be an evanescent and the doubled spatial frequency.

The evanescent wave associated with the standing wave will be amplified by the negative index layer 22, and will interact with the propagating wave 34. The resultant modified propagating wave will contain an amplified modulation corresponding to the spatial pattern 14, and will interact in the farfield as well, resulting in standing waves all throughout the medium 24˜at all locations where the cavity supports maximum electric fields for the propagating wave.

Thus, this process results in the transfer of information contained in initial evanescent electromagnetic energy 44 emanating from the first surface 40 of the negative-index layer 22 to the top surface 42 of the photoresist layer 26. This information may couple to propagating electromagnetic energy 32, 34 within the gap 24 and be transferred to the photoresist layer 42. Alternatively, the propagating energy 32, 34 within the gap 24 may be thought of as containing or representing non-decaying evanescent electromagnetic energy to the extent that the spatial frequency of the propagating electromagnetic energy 34 corresponds to sub-diffraction resolutions, e.g., beam spacings less than the diffraction limit associated with the incident electromagnetic energy 14.

Hence, the gap 24 is adapted to support strong maxima in the electric fields associated with the propagating waves (the cavity resonance condition);

Further, at each cavity reflection at the gap/photoresist interface, additional evanescent waves 36 are generated in the photoresist layer 26. Similarly at each reflection from the first surface 40 of the negative-index layer, evanescent waves 44 are generated at the first surface 40. These evanescent waves 44 are thought to be amplified by the negative index layer 22.

The combination of the negative index layer 22 and the resonant cavity formed in the gap 24 results in interference between propagating waves, interaction between propagating and evanescent waves, and the amplification of the evanescent waves. From the performance viewpoint, the combination of the negative index layer 22 and the resonant cavity represented by the gap 24 results in the transmission and regeneration of evanescent waves at locations in the far field from the negative index layer 22. Depending on the sources of the evanescent waves and propagating waves, the spatial pitch corresponding to the evanescent waves 36 at the photoresist surface 26 could be doubled from that of patterned light 14, or it could have the same spatial pitch. This phenomenon can be exploited to imprint high-resolution lines on the photoresist. For illustrative purposes, high-resolution spots 46 corresponding to evanescent field patterns generated at the photoresist surface 42 correspond to the pattern of the patterned light 14 but with double the spatial frequency. Note that the photoresist surface 42 is positioned beyond the near field distance from the output surface 40 of the superlens 30.

Note that if the spatial frequency of the patterned incident electromagnetic energy 14 is doubled at the surface 42 of the photoresist layer 26, this results in halving of the distances between corresponding spots at the photoresist surface 42, which may result in halving of the sizes of features that can be imaged at the photoresist surface 42.

The present nanolithography system 10 is called a far field superlens lithography system, as it employs a single superlens 30 and other phenomenon to recreate sub-diffraction (or super resolution) patterns in the far field. A superlens may be any lens or device capable of yielding an image characterized by a resolution less than the diffraction limit associated with electromagnetic energy used to produce the image. Superlenses discussed herein are considered to include both a positive-index layer and a negative-index layer and may further include a cavity, gap, or dielectric layer positioned at an output aperture of a negative-index material. However, a single negative-index layer alone is sometimes called a superlens. The specific superlens 30 discussed herein is adapted to operate in the far field, such that it is capable of producing sub-diffraction-limited images at the photoresist surface 42, which is positioned at a far field distance from the output surface 40 of the negative-index layer 22. Note that in a conventional superlens, far field imaging using evanescent electromagnetic energy is generally not thought possible due to inherent decay of evanescent electromagnetic energy generated by a conventional superlens.

In summary, the far-field superlens 30 discussed herein with reference to FIG. 1 may exploit the interaction of propagating and evanescent light to convey very high resolution patterns and into the far field. A far-field superlens may be any superlens adapted to generate a sub-wavelength image or a sub-diffraction-limited image at a far field distance from a negative-index material included in the superlens. For the purposes of the present discussion, a sub-diffraction-limited image may be any image wherein the smallest feature sizes thereof are less than approximately ½ the wavelength of incident electromagnetic energy, which correspond to feature sizes less than the diffraction limit associated with the electromagnetic energy.

In the present specific embodiment, the far-field superlens 30 includes one or more layers of aluminum 22 (which has a negative index at 157 nm and at 193 nm) and positive-index material 18 (such as PolyMethyl MethAcrylate (PMMA)). Patterned light 14 is incident on the superlens 30 at or near the diffraction limit. Patterned light or electromagnetic energy is said to be at or near the diffraction limit if spacings between geometrical components or features of the light, such as beam spacings, or other spatial beam features (e.g., beam width), are at or near the diffraction limit associated with the light.

For the purposes of the present discussion, a beam feature may be any component or portion of an image corresponding to a beam or component of a beam used to generate the image. An example beam feature includes a spot on a surface created by a beam, or a grouping of spots on a surface created by a beam that has been patterned to produce the spots.

The evanescent waves exiting the superlens 30 are amplified, and both the evanescent and propagating waves travel in or extend into the gap 24. Initially generated evanescent fields 44 at the output aperture 40 of the negative-index layer 22 may decay substantially, but nevertheless, the propagating waves within the gap 24 facilitate preserving information contained in the initially generated evanescent fields and facilitate transferring the information (e.g., pattern information) to a second surface, i.e., the surface 42 of the photoresist layer 26. The second surface 42 represents an imaging surface. For the purposes of the present discussion, an imaging surface may be any surface upon which an image is formed or to be formed.

The propagating waves 32, 34 reflect within the gap 24, where the first surface 40 of the negative-index material acts as a mirror for the propagating waves, and may also re-amplify evanescent waves. Thus, in this embodiment, an interaction of the propagating waves (which are substantially preserved) and the evanescent waves (which are substantially decayed with distance, but amplified by the negative index layer) may be setup.

Hence, the far field lithography system 10 includes various layers 18, 22 24, 26, the thicknesses of which are optimized to produce evanescent waves in the near field, and cavity enhanced propagating waves. In one embodiment, the far-field superlens is used as a lithography tool and in a second embodiment; the far-field superlens is used as a metrology tool. Other embodiments are also possible.

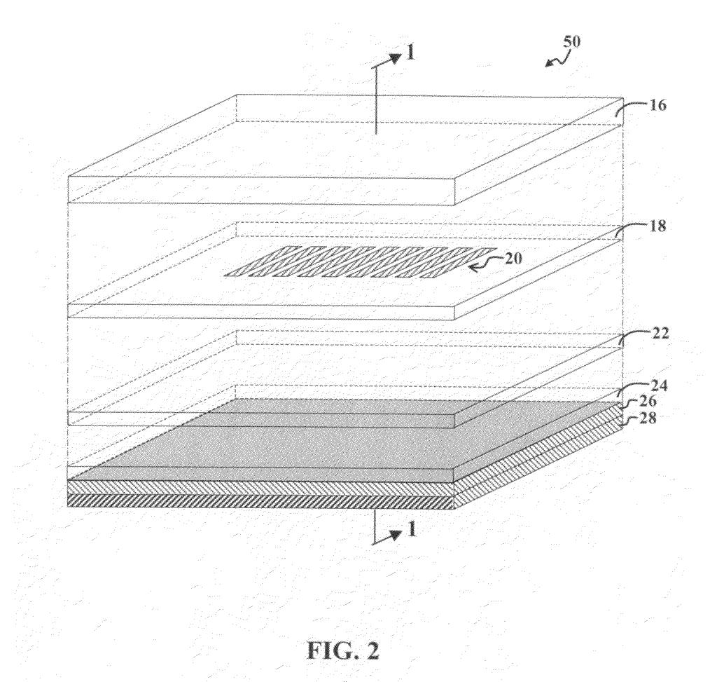

FIG. 2 is a partially exploded perspective view of an alternative embodiment 50 of the nanolithography system 10 of FIG. 1. Note that while the various layers 16-28 are shown with substantially square horizontal dimensions, other shapes are possible. The embodiment 50 differs from the system 10 of FIG. 1 in that the mask 20 is positioned on, within, or adjacent to the positive-index layer 18 instead of at the output aperture of the imaging source 12 of FIG. 1.

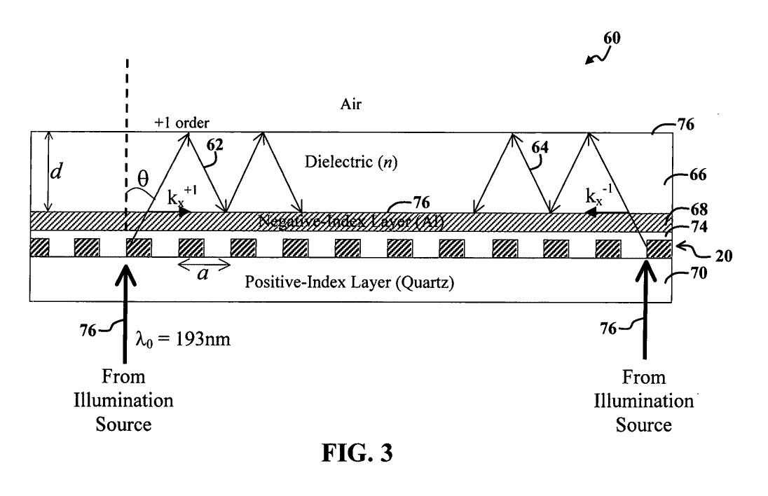

FIG. 3 is a diagram of a second example superlens 60 illustrating propagation of electromagnetic energy 62, 64 within a cavity formed by a dielectric layer 66 positioned adjacent to a negative-index layer 68. In the present specific embodiment, the mask 20 is positioned atop a positive-index quartz layer 70 and is surrounded by a second positive-index filler layer 74. The negative-index layer 68 is positioned atop the filler layer 74, and the dielectric cavity layer 66 (with an index or refraction denoted by n) is disposed on the negative-index aluminum layer 68.

In operation, incident light 76 impinges upon the quartz layer 70 and is patterned by the mask 20. The mask 20 diffracts the incident light resulting in propagating electromagnetic energy 62, 64 within a cavity formed in the via the cavity dielectric layer 76. The propagating light 62, 64 oscillates within the cavity, an oppositely angled or diffracted propagating light components 62, 64 set up standing waves within the cavity 66 by virtue of their opposing wave vectors (represented by kx+1 and kx−1, respectively).

In particular, the propagating light 62, 64 is diffracted onto an angle in accordance with the following equation:

$$α sin θ = \frac{l {λ}_{o}}{n} , \qquad [ 2 ]$$

where a is the pitch of the mask 20 (and is approximately 150 nm in the present embodiment), also called a grating; λo is the free space wavelength (which is approximately 193 nm in the present embodiment); 1 is the diffraction order, which takes on integer values; θ is the diffraction angle as shown in FIG. 3; and n is the refractive index (which is approximately 1.7 in the present embodiment), i.e., index of refraction of the dielectric cavity layer 66

The dielectric cavity layer 66 supports a cavity resonance characterized by the following equation:

2nd cos θ=mλ₀, [3]

where m takes on whole numbers; d represents the thickness of the dielectric cavity layer 66. For the case where m=1 and l=1, d is approximately integral multiples of 87 nm. In the present specific embodiment, θ is approximately 49 degrees.

The standing wave corresponding to the two x components of +1 and −1 orders decreases the spatial pitch to a/2 with feature size of a/4; creating the wave vector 2kₓ. The superlens corresponding to the negative-index layer 68 amplifies 2kₓ, thereby ensuring that it does not decay to 0 for subsequent internal reflections. The propagating wave 62 interacts with this amplified wavevector, and conveys it into the farfield.

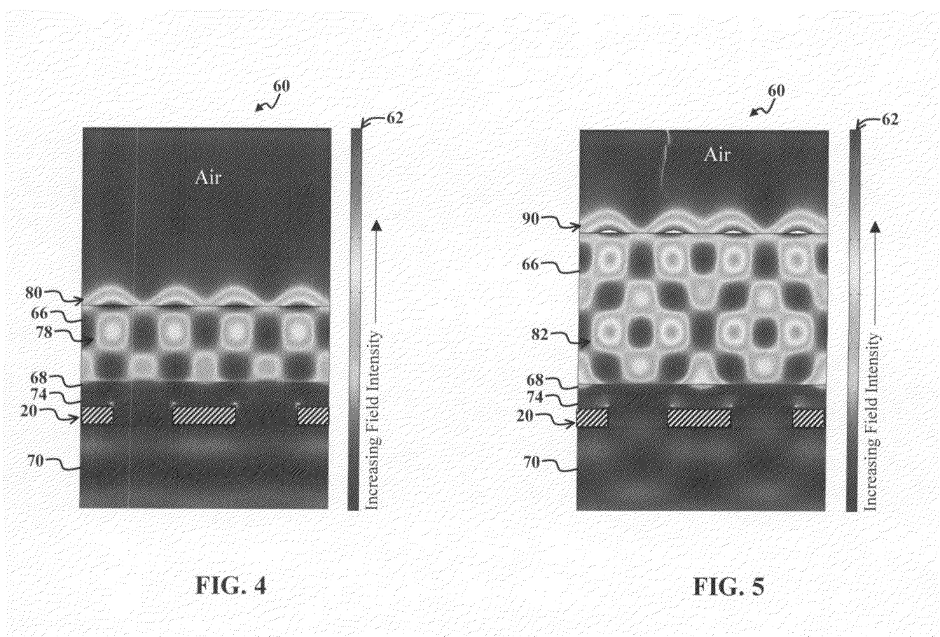

FIG. 4 is a diagram illustrating example electromagnetic field intensity patterns in the cavity 66 of FIG. 3 for a dielectric cavity layer thickness of approximately 90 nanometers. The diagram of the superlens 60 of FIG. 3 includes a legend for an electromagnetic field intensity pattern 78 set up within the dialectic cavity layer 68. The field intensity pattern 78 was generated using a console that iteratively solves Maxwell's equations to obtain an accurate representation of field behavior. With reference to FIGS. 3 and 4, note that evanescent fields 80 are transferred to a top surface 76 of the dielectric cavity layer 68. In other words, evanescent waves 80 are recreated at a dielectric/air interface with a 2k wave vector.

FIG. 5 is a diagram illustrating example electromagnetic field intensity patterns 82 in the cavity of FIG. 3 for a dielectric layer thickness of approximately 180 nanometers.

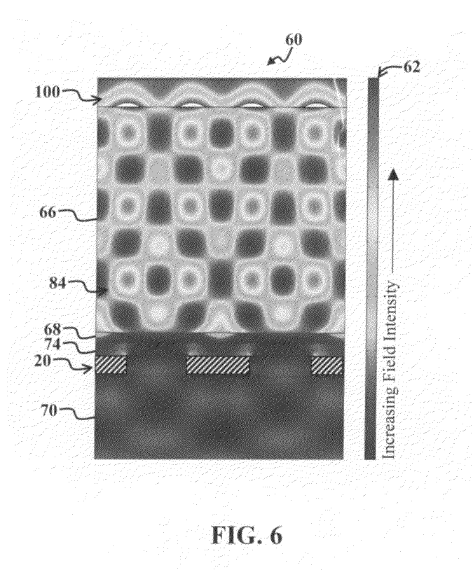

FIG. 6 is a diagram illustrating example electromagnetic field intensity patterns 84 in the cavity of FIG. 3 for a dielectric layer thickness of approximately 267 nanometers.

With reference to FIGS. 4-6, note that the overall field intensities 78, 82, 84 including those of the respective evanescent fields 80, 90, 100 remain comparable even for thicker dielectric materials.

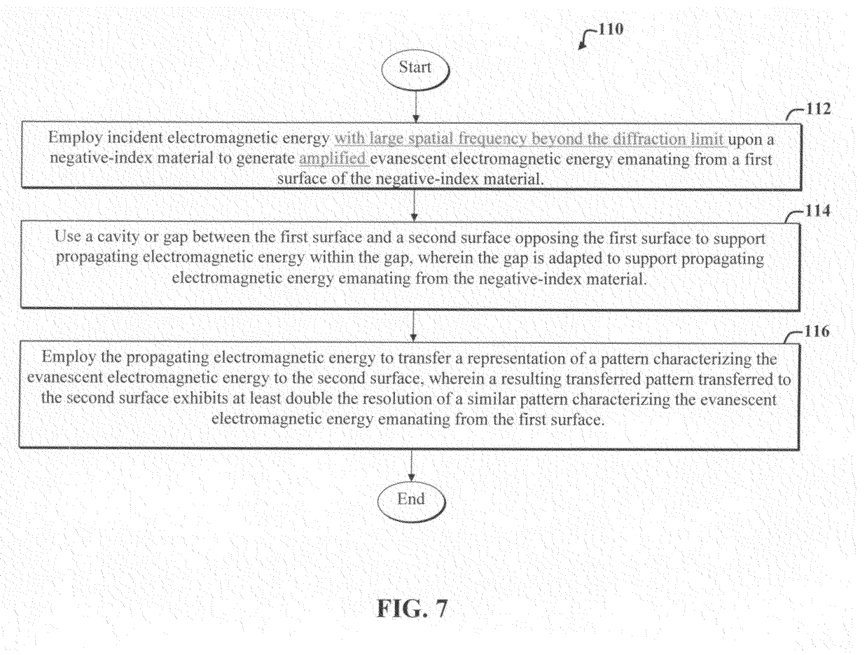

FIG. 7 is a flow diagram of an example method 110 adapted for use with the superlenses 10, 60 of FIGS. 1 and 3. The method 110 includes a first step 112, which includes employing incident electromagnetic energy upon a negative-index material to generate evanescent electromagnetic energy emanating from a first surface of the negative-index material.

A second step 114 includes using a cavity or gap between the first surface and a second surface opposing the first surface to support propagating electromagnetic energy within the gap, wherein the gap is adapted to resonantly support propagating electromagnetic energy emanating from the negative-index material.

A third step 116 includes employing the propagating electromagnetic energy to transfer a representation of a pattern characterizing the evanescent electromagnetic energy to the second surface, wherein a resulting transferred pattern transferred to the second surface exhibits at least double the resolution of a similar pattern characterizing the evanescent electromagnetic energy emanating from the first surface.

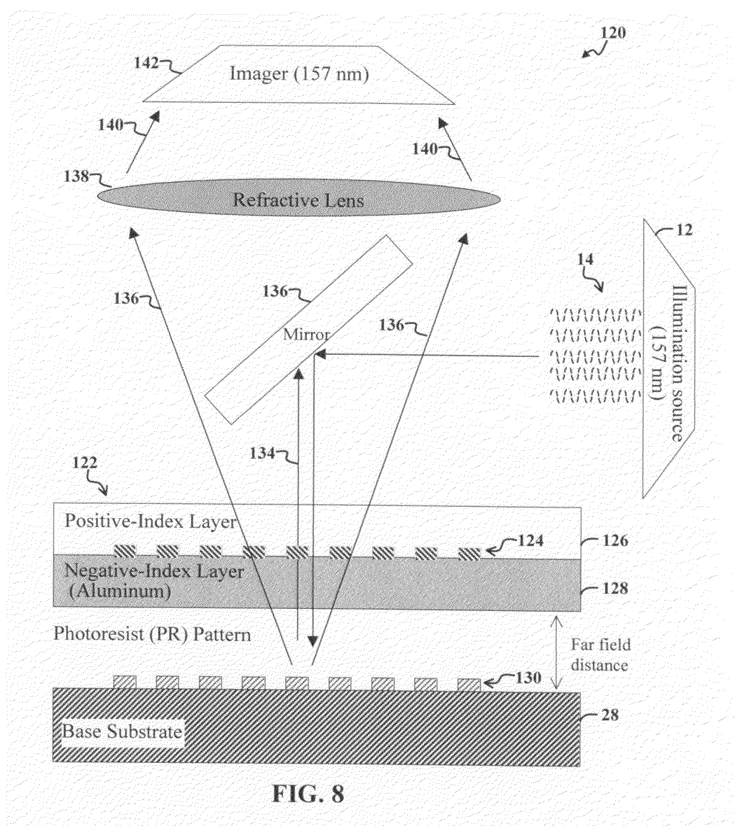

FIG. 8 is a diagram of a single-far-field superlens metrology (inspection) system 120 according to a third example embodiment. Note that while the metrology system 120 is discussed with respect to a modified superlens 122, the superlenses of FIGS. 1-3 may be employed in the metrology system 120 without departing from the scope of the present teachings. Also note that several other embodiments of the metrology system can be constructed using the general teachings described here with system 120.

The system 120 includes a modified far-field superlens 122 with a control grating 124 (also called the lens grating) positioned at an interface between a positive-index layer 126, such as silica, and a negative-index layer 128, such as aluminum (Al). A mirror 136, which also represents a dark-field stop, as discussed more fully below, is positioned to direct electromagnetic energy 14 output from the illumination source 12 perpendicular to an input aperture of the positive-index layer 126 and to block a desired portion of backscattered electromagnetic energy 134 while allowing backscattered dark-field electromagnetic energy 136 to pass to a refractive lens 138 positioned behind the mirror 136. Hence, the mirror 136 is positioned between the superlens 122 and the refractive lens 138. The refractive lens 138 is positioned between the mirror 136 and an imager 142. The refractive lens 138 is adapted to focus the dark-field energy 136, resulting in focused dark-field energy 140, which is imaged by the imager 142. Note that the imager 142 may include a computer running appropriate algorithms to analyze the resulting focused dark-field energy 140. Suitable materials for construction of the refractive lens 138 include CaF₂ and/or MgF₂, but other materials may be employed.

A base substrate 28 is positioned proximate to the negative-index layer 128 and includes a pattern 130 thereon or adjacent thereto. The pattern 130 is positioned on a side of the base substrate 28 closest to the negative-index layer 128 and within the near field of electromagnetic energy exiting the negative-index layer 128.

For the purposes of the present discussion, the near field corresponds to a region extending from a surface to approximately one wavelength of electromagnetic energy of interest. Hence, the near-field region at the output aperture of the negative-index layer 128 represents a region substantially less than the wavelength of the incident electromagnetic energy, e.g., less than 157 nm from the surface.

Evanescent waves exiting the output aperture of the negative-index layer 128 are generally contained within the near field of the output aperture of the negative-index layer 128. However, use of the farfield superlens design (which includes control of the farfield distance) as described previously conveys the evanescent waves into the farfield, and onto the pattern being imaged 130.

In an example operative scenario, the illumination source 12 directs electromagnetic energy 14 with a center frequency corresponding to a wavelength of approximately 157 nm toward a reflective surface of the mirror 136. The mirror 136 directs the electromagnetic energy 14 perpendicular to the positive-index layer 122. The electromagnetic energy 14 passes through the positive index layer 122 and is partially scattered by the control grating 124. In the present example embodiment, the control grating 124 includes substantially parallel rectangular strategically spaced metallic (e.g., Al) features. The cross-sectional dimensions of the metallic features 124 and the spacings are comparable to the diffraction limit characterizing the incident electromagnetic energy 14. Evanescent waves exiting the grating 124 are amplified by the negative-index layer 128. For the purposes of the present discussion, a wave vector may be a vector representation of a wave or portion thereof, and may include a direction component that indicates a direction of wave propagation and a magnitude component corresponding to a wave number or wavelength reciprocal.

The resulting amplified evanescent electromagnetic energy travelling in the negative-index layer 128 results in amplified evanescent waves exiting the output aperture of the superlens 122, which corresponds to the output aperture of the negative-index layer 128. When the system 120 is operated in metrology mode, the pattern 130 to be inspected is positioned in the farfield of the farfield superlens 122, but in a location where the farfield superlens supports the regeneration of evanescent waves as discussed previously.

The pattern 130 imparts a second wave vector component to the backscattered energy. The difference between wave vector contributions from the control grating 124 and the pattern 130 result in components characterized by wavevectors less than the diffraction limit, which corresponds to propagating light 137 that scatters into the farfield. This propagating light is collected by the lens 138 and focused onto an imager 142 and analyzed by appropriate analysis algorithms.

For the purposes of the present discussion, wave-vector differencing may refer to any method that employs a difference in wave vectors of electromagnetic energy to scatter light into the farfield. Hence, the system 120 employs wave-vector differencing to facilitate imaging defects or other features of the pattern 130.

Some of the electromagnetic energy 14 incident on the pattern 130 is scattered away from the normal to the substrate 28 and pattern 130, while a substantial portion, called the reflected main beam, is reflected back and blocked, i.e., stopped by the mirror 136. This prevents overwhelming the darkfield energy 136 of interest. Backscattered energy 136 represents the darkfield to be imaged and analyzed.

The control grating 124 and the pattern 130 to be analyzed are positioned in close enough proximity to each other to enable information carried in evanescent waves to pass between the control grating 124 and the pattern 130 to prevent prohibitive decay of the evanescent waves traveling therebetween. Accordingly, the pattern 130 is positioned in the near field of the output aperture of the negative-index layer 128 and within an evanescent wave decay length from the control grating 124 given the amplifying negative-index layer 128 therebetween.

When the system 120 is operated in lithography mode, the pattern 130 is replaced with a photoresist to be patterned. The incident electromagnetic energy 14 is then masked by the pattern 124, resulting in selective denaturing of the underlying photoresist, thereby enabling the photoresist to be patterned accordingly.

Note that the various beams of electromagnetic energy 14, 134, 136 are shown for illustrative purposes and are not representative of exact beam paths. For example, in practice, electromagnetic energy passing through the superlens 122 will be refracted and deflected in accordance with Snell's Law, given the indices of refraction of the various layers 124-128 of the superlens 122 and the ambient media, which may be air or vacuum in the present example embodiment.

While the system 120 is primarily discussed as being a metrology or lithography tool, note that it may be used for simultaneous lithography and metrology and/or for other purposes.

When operating in metrology mode, the system 120, also called a tool 120, facilitates inspecting the pattern 130 for defects. In the present specific embodiment, the pattern 130 has a characteristic length scale much smaller than the diffraction limit of light, even at 157 nm. Thus, certain existing metrology methods would produce a very weak (if any) signature for such characteristics. The system 120 and accompanying metrology method discussed herein produces a stronger more accurate signal to detect sub-diffraction-sized defects.

In summary, in the present example embodiment, the illumination source 12, operating at 157 nm, illuminates the mirror 136. The resulting electromagnetic energy 14 is focused onto or otherwise directed onto the superlens 122. The superlens 122 focuses the electromagnetic energy 14 onto the pattern 130. The grating 124 includes a period similar to the pattern 130.

If the difference in wave vectors associated with the grating in the lens 122 and the pattern being inspected 130 is smaller than the diffraction limit, then the resulting backscattered light 136 will propagate into the farfield, and can be collected by the refractive lens 138

The efficiency of the system 120, which may also be called a farfield superlensed tool, is affected by the combination of the positive-index layer 126 and the negative-index layer 128, and the optimized gap that can support resonances in the propagating light.

Those skilled in the arts will recognize other variants of the invention that can be constructed from the general principle described here. An alternative embodiment would be to project a grating like light source onto the location marked by the grid 124, instead of having a physical grid present at this location. Thus, this grating produces an electromagnetic wave with wave vector close to the diffraction limit. The pattern being inspected is in the far field of the metamaterial far-field superlens.

While various embodiments have been discussed herein with respect to superlenses using thin metallic layers, and metamaterials lenses for far-field lithography, embodiments are not limited thereto. For example, metamaterials may be employed to implement superlenses at higher or lower frequencies (than 157 nm) and may be used with immersion lithography techniques discussed herein without departing from the scope of the present teachings. Furthermore, while various embodiments have been discussed with respect to use for nanolithography and/or nanometrology, embodiments are not limited thereto. For example, certain embodiments discussed herein may be used to create and/or inspect features that are larger than nanoscale features, without departing from the scope of the present invention.

Exact materials and dimensions of various components employed to implement embodiments discussed herein are application specific. Those skilled in the art with access to the present teachings may readily employ desired materials to meet the needs of a given application.

Although the invention has been discussed with respect to specific embodiments thereof, these embodiments are merely illustrative, and not restrictive, of the invention. In the description herein, numerous specific details are provided, such as examples of components and/or methods, to provide a thorough understanding of embodiments of the present invention. One skilled in the relevant art will recognize, however, that an embodiment of the invention can be practiced without one or more of the specific details, or with other apparatus, systems, assemblies, methods, components, materials, parts, and/or the like. In other instances, well-known structures, materials, or operations are not specifically shown or described in detail to avoid obscuring aspects of embodiments of the present invention.

Reference throughout this specification to “one embodiment”, “an embodiment”, or “a specific embodiment” means that a particular feature, structure, or characteristic described in connection with the embodiment is included in at least one embodiment of the present invention and not necessarily in all embodiments. Thus, respective appearances of the phrases “in one embodiment”, “in an embodiment”, or “in a specific embodiment” in various places throughout this specification are not necessarily referring to the same embodiment. Furthermore, the particular features, structures, or characteristics of any specific embodiment of the present invention may be combined in any suitable manner with one or more other embodiments. It is to be understood that other variations and modifications of the embodiments of the present invention described and illustrated herein are possible in light of the teachings herein and are to be considered as part of the spirit and scope of the present invention.

It will also be appreciated that one or more of the elements depicted in the drawings/figures can also be implemented in a more separated or integrated manner, or even removed or rendered as inoperable in certain cases, as is useful in accordance with a particular application.

Furthermore, the term “or” as used herein is generally intended to mean “and/or” unless otherwise indicated. Combinations of components or steps will also be considered as being noted, where terminology is foreseen as rendering the ability to separate or combine is unclear.

As used in the description herein and throughout the claims that follow “a”, “an”, and “the” include plural references unless the context clearly dictates otherwise. Furthermore, as used in the description herein and throughout the claims that follow, the meaning of “in” includes “in” and “on” unless the context clearly dictates otherwise.

The foregoing description of illustrated embodiments of the present invention, including what is described in the Abstract, is not intended to be exhaustive or to limit the invention to the precise forms disclosed herein. While specific embodiments of, and examples for, the invention are described herein for illustrative purposes only, various equivalent modifications are possible within the spirit and scope of the present invention, as those skilled in the relevant art will recognize and appreciate. As indicated, these modifications may be made to the present invention in light of the foregoing description of illustrated embodiments of the present invention and are to be included within the spirit and scope of the present invention.

Thus, while the present invention has been described herein with reference to particular embodiments thereof, a latitude of modification, various changes and substitutions are intended in the foregoing disclosures, and it will be appreciated that in some instances, some features of embodiments of the invention will be employed without a corresponding use of other features without departing from the scope and spirit of the invention as set forth. Therefore, many modifications may be made to adapt a particular situation or material to the essential scope and spirit of the present invention. It is intended that the invention not be limited to the particular terms used in following claims and/or to the particular embodiment disclosed as the best mode contemplated for carrying out this invention, but that the invention will include any and all embodiments and equivalents falling within the scope of the appended claims.

Thus, the present invention has been described herein with reference to a particular embodiment for a particular application. Those having ordinary skill in the art and access to the present teachings will recognize additional modifications, applications, and embodiments within the scope thereof.

It is therefore intended by the appended claims to cover any and all such applications, modifications and embodiments within the scope of the present invention.

Accordingly,

What is claimed is:

1. An apparatus for creating a sub-wavelength image, the apparatus comprising:
a far-field superlens.

2. The apparatus of claim 1 wherein the far-field superlens includes:
a positive-index material;
a negative-index material adjacent to the positive-index material, the negative-index material having an output aperture at a first surface; and
a second surface that is positioned at a far field distance from the negative-index material such that a cavity is formed between the second surface and the first surface, wherein the second surface represents an imaging surface.

3. The apparatus of claim 2 further including first means for producing one or more sub-diffraction-limited beam features at a far field distance from the negative-index layer via the interaction of propagating waves that travel to the farfield, and evanescent waves that are, in the absence of the interaction, confined to the nearfield.

4. The apparatus of claim 3 wherein the cavity is adapted to support creation of the sub-diffraction-limited beam features at a far field distance from the negative index layer via generation of one or more evanescent fields at the second surface.

5. The apparatus of claim 2 wherein the second surface is adapted to support an image corresponding to a pattern of electromagnetic energy incident upon an input aperture of the negative-index material, wherein the image corresponding to the pattern is characterized by a resolution that is at least double a resolution of the pattern.

6. An apparatus for creating a sub-wavelength image, the system comprising:
first means for employing patterned incident electromagnetic energy to generate evanescent electromagnetic energy within a near-field distance of a first surface; and
second means for employing the interaction of propagating electromagnetic energy within a gap formed between the first surface and a second surface to transfer a representation of the evanescent electromagnetic energy to the second surface.

7. The apparatus of claim 6 wherein the representation of the evanescent electromagnetic energy at the second surface is characterized by a pattern at the second surface, wherein the pattern at the second surface is representative of a pattern of the patterned incident electromagnetic energy, with the exception the pattern at the second surface is characterized by a resolution that is greater than or equal to double the resolution the pattern of the patterned incident electromagnetic energy.

8. The apparatus of claim 6 wherein the gap includes a dielectric material.

9. The apparatus of claim 8 wherein the second surface corresponds to an interface between the dielectric material and air or vacuum.

10. The apparatus of claim 6 wherein the gap includes air or a vacuum.

11. The apparatus of claim 6 wherein the second surface includes photoresist.

12. The apparatus of claim 11 wherein the photoresist is adapted to reflect electromagnetic energy propagating within the gap back to the first surface, thereby generating additional evanescent fields at the first surface.

13. The apparatus of claim 12 wherein the gap is adapted to support coupling of evanescent electromagnetic energy to propagating electromagnetic energy within the gap; transfer of resulting coupled electromagnetic energy to the second surface; and generation of evanescent fields at the second surface.

14. The apparatus of claim 13 wherein the evanescent fields at the second surface are characterized by a pattern with a resolution that is double or more than a resolution of a pattern existing in evanescent electromagnetic energy at the first surface.

15. The apparatus of claim 11 wherein the gap is adapted to support interference of propagating electromagnetic energy transiting a negative-index material of the first means and reflecting off sidewalls of the gap, wherein the sidewalls include the first surface and the second surface.

16. The apparatus of claim 15 wherein the interference is adapted to double or quadruple a spatial frequency of one or more patterns characterizing the patterned incident electromagnetic energy.

17. The apparatus of claim 15 wherein the first surface includes aluminum (Al).

18. The apparatus of claim 6 further including a metrology device incorporating the superlens and the imaging surface, wherein the metrology device is adapted to employ wave-vector differencing to detect features or defects on a surface.

19. An apparatus for creating a sub-diffraction far-field image, the apparatus comprising:
a superlens including a negative-index material, wherein the negative-index material is partially transmissive to electromagnetic energy incident on an input aperture of the superlens;
an imaging surface positioned at a far field distance from a surface of the negative-index material so that a cavity is formed between the imaging surface and the surface of the negative-index material.

20. The apparatus of claim 19 wherein a dielectric constant of a medium in the cavity is adapted to enable multiple reflections of propagating electromagnetic energy within the cavity, where the multiple reflections include reflections from the negative-index material and the imaging surface.

21. The apparatus of claim 19 wherein the imaging surface includes photoresist.

22. The apparatus of claim 19 further including means for transmitting incident electromagnetic energy on an input aperture of the superlens, wherein the incident electromagnetic energy is characterized by a predetermined pattern with feature sizes at or larger than ½ a wavelength of the incident electromagnetic energy.

23. The apparatus of claim 22 wherein the pattern includes plural beams, wherein two or more of the plural beams are separated by a distance that greater than or equal to ½ the wavelength of the incident electromagnetic energy.

24. The apparatus of claim 23 wherein refractive indexes of the negative-index layer and a medium in the gap, and wherein a spacing between the imaging surface and the negative-index material are chosen to enable transfer of information contained in evanescent fields at a surface of the negative-index material to the imaging surface.

25. The apparatus of claim 24 wherein the cavity is adapted to result in interference of propagating electromagnetic energy reflecting within the cavity, thereby resulting in increased spatial frequency of electromagnetic energy formed at the imaging surface.

26. The apparatus of claim 24 wherein the increased spatial frequency includes a reduction by a factor of two or more of feature sizes characterizing the incident electromagnetic energy.

27. The apparatus of claim 19 further including a metrology device incorporating the superlens and the imaging surface, wherein the metrology device is adapted to employ wave-vector differencing to detect features or defects on a surface.

28. An apparatus for creating a sub-wavelength image, the apparatus comprising:
first means for generating evanescent electromagnetic energy within a near-field distance of a first surface from incident electromagnetic energy;
second means for coupling the evanescent electromagnetic energy to electromagnetic energy capable of far-field propagation; and
third means for supporting an image with feature sizes less than ½ a wavelength of incident electromagnetic energy at a surface positioned further than ½ of a wavelength from the first means by employing the second means and the electromagnetic energy capable of far-field propagation to transfer information contained in the evanescent electromagnetic energy to the third means.

29. An method for creating a sub-wavelength image, the method comprising:
employing patterned incident electromagnetic energy to generate evanescent electromagnetic energy within a near-field distance of a first surface; and
using interference of electromagnetic energy within a gap formed between the first surface and a second surface to transfer a representation of the evanescent electromagnetic energy to the second surface.

30. The method of claim 29 wherein the representation of the evanescent electromagnetic energy is characterized by a pattern with a spatial frequency that is twice or more than a spatial frequency characterizing a pattern of the evanescent electromagnetic energy.

31. The method of claim 29 wherein employing further includes generating evanescent electromagnetic energy within a near-field distance of the first surface from incident electromagnetic energy that is incident upon a superlens; coupling the evanescent electromagnetic energy to propagating electromagnetic energy; and supporting an image with feature sizes less than ½ a wavelength of incident electromagnetic energy at the second surface.

32. The method of claim 31 wherein the second surface is positioned further than ½ of a wavelength from the first surface.

33. The method of claim 31 wherein the propagating electromagnetic energy within the gap is adapted to transfer information contained in the evanescent electromagnetic energy to the third means.

34. An method for creating a sub-wavelength image, the method comprising:
employing incident electromagnetic energy upon a negative-index material to generate evanescent electromagnetic energy emanating from a first surface of the negative-index material;
using a cavity or gap between the first surface and a second surface opposing the first surface to support propagating electromagnetic energy within the gap, wherein the gap is adapted to support propagating electromagnetic energy emanating from the negative-index material; and
employing the propagating electromagnetic energy to transfer a representation of a pattern characterizing the evanescent electromagnetic energy to the second surface, wherein a resulting transferred pattern transferred to the second surface exhibits at least double the resolution of a similar pattern characterizing the evanescent electromagnetic energy emanating from the first surface.
